(19) United States
(12) Patent Application Publication
(10) Pub. No.: US 2002/0108630 A1
(43) Pub. Date: Aug. 15, 2002

(54) Dental floss

(76) Inventor: Albert Shau, Palo Alto, CA (US)

Correspondence Address: Albert Shau, 991 Amarillo Ave., Palo Alto, CA, 94303, US

(21) Appl. No.: 09/781,086

(22) Filed: Feb. 12, 2001

(51) Int. Cl. A61C 15/00

(52) U.S. Cl. 132/323

(57) ABSTRACT

This invention was made to better the health of people's gums. The invention is capable of flossing multiple teeth simultaneously. In this way, the time flossing takes is cut dramatically. The invention provides flexibility to adapt for individual users allowing a wide range of people to use the same product. The invention is easy to manufacture as it consists of only 2 parts. Every part can be made out of inexpensive material making this floss device very cost-efficient.

### BACKGROUND OF THE INVENTION

The present invention relates to dental cleaning devices, and more particularly dental floss.

Flossing has always been necessary for clean teeth, Unfortunately, flossing by hand is both bothersome and painful because you must wrap the floss around two fingers and in order to keep the line taunt, you must pull in opposite directions with your hands which also causes pain in the fingers. This is also time-consuming because you have to do one tooth at a time. Basically, flossing is an important, but irritating job. There have been almost no inventions to make flossing more enjoyable and less time-consuming.

One simple device has been developed to allow people to floss more comfortably. Floss is attached to a plastic unshaped object which, in turn, is on the end of a plastic stick. This way, a person can floss their teeth by holding on to a plastic stick. This eliminates the pain somebody experiences while wrapping floss around the fingers. However, this product still only flosses one tooth at a time. Also, it cannot be customized to the user's comfort.

Flossing has always taken time because of the fact that only one tooth can be flossed at a time. It is also not comfortable. Therefore, it is desirable to have a product that flosses many teeth at a time and is also very flexible so that the user may customize it to his/her comfort.

### SUMMARY OF THE INVENTION

The primary objective of this invention is, therefore, to make flossing less time consuming. The other objective is to make flossing more comfortable. The major reason why people don't like to floss is that it takes a lot of time to do it well and it is very uncomfortable. By flossing multiple teeth, the time it takes to floss is greatly reduced. This way, people will floss more regularly to improve the condition of the gums and teeth. By connecting multiple strands of floss to one long unit, you can floss multiple teeth by just moving that one unit. The flossing device is also customizable meaning you can customize it to your comforts and/or needs to make flossing easier. This means anybody could floss all their teeth in a matter of seconds regardless of variety in the distance between teeth and shape of the gumline.

While the novel features of the invention are set forth with particularly in the appended claims, the invention, both as to organization and content, will be better understood and appreciated, along with other objects and features thereof, from the following detailed descriptions taken in conjunction with the drawings.

### BRIEF DESCRIPTION OF THE DRAWINGS

FIG. 1 shows one example of a flossing device of the present invention in its entirety;

FIG. 2(a) illustrates the floss attachment in FIG. 1; and

FIGS. 3(a, b) show another embodiment of the flossing device of the present invention.

### DETAILED DESCRIPTION OF THE INVENTION

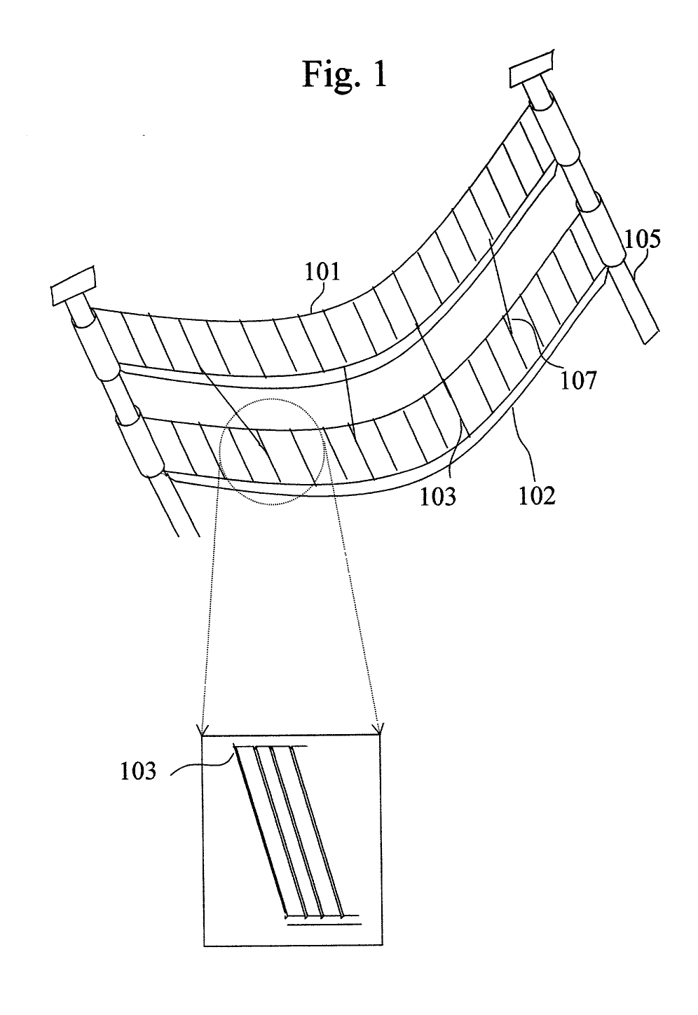

FIG. 1 shows the basic layout of the flossing device. It consists of floss attachment devices (101, 102), and rods (105). Floss (107) is attached to both floss attachment devices. Each floss attachment device has many tiny slits (103). The floss is inserted into a slit and attached to another slit on the other floss attachment device. The rods are simply long cylindrical objects that are used to keep the two floss attachment devices attached to each other. Flossing of multiple teeth is achieved by inserting floss between teeth and moving the entire device up, down, left and right.

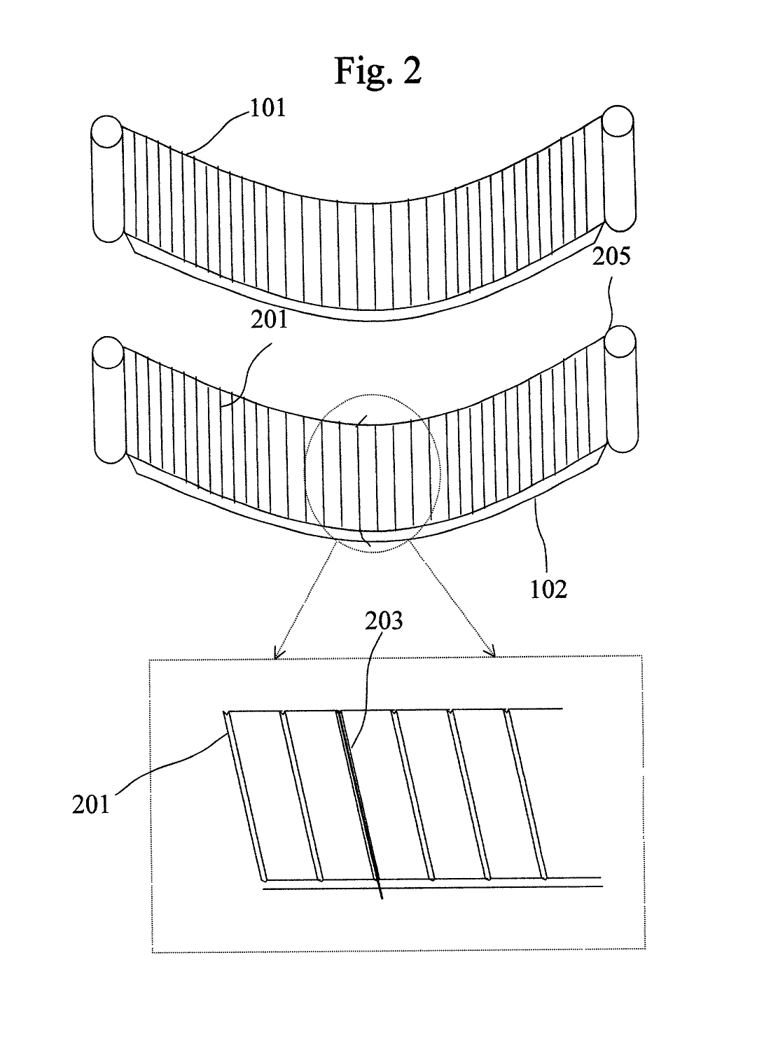

FIG. 2(a) illustrates the floss attachment devices (101, 102). Each floss attachment device is slightly curved. This is so that they will mimic the gumline as closely as possible. On the surface of both floss attachment devices (101, 102) are little slits (201) as shown in the enlarged view. The floss (203) is inserted into the slit and because of the thinness of the slit; the floss will stay in place. One end of a short strand of floss is attached to different floss attachment devices forming taunt strands that are inserted between teeth and then moved around to remove plaque. There are many slits on each floss attachment allowing each person to customize where the floss is and what position it takes. This allows all people to use the same flossing device regardless of differences in distance between teeth and/or differences in the position of teeth. On both ends of the floss attachment device is a tube (205). The tube is a hollow cylinder. The tube is used in tangent with the rod in order to keep the two floss attachment devices(101, 102) together.

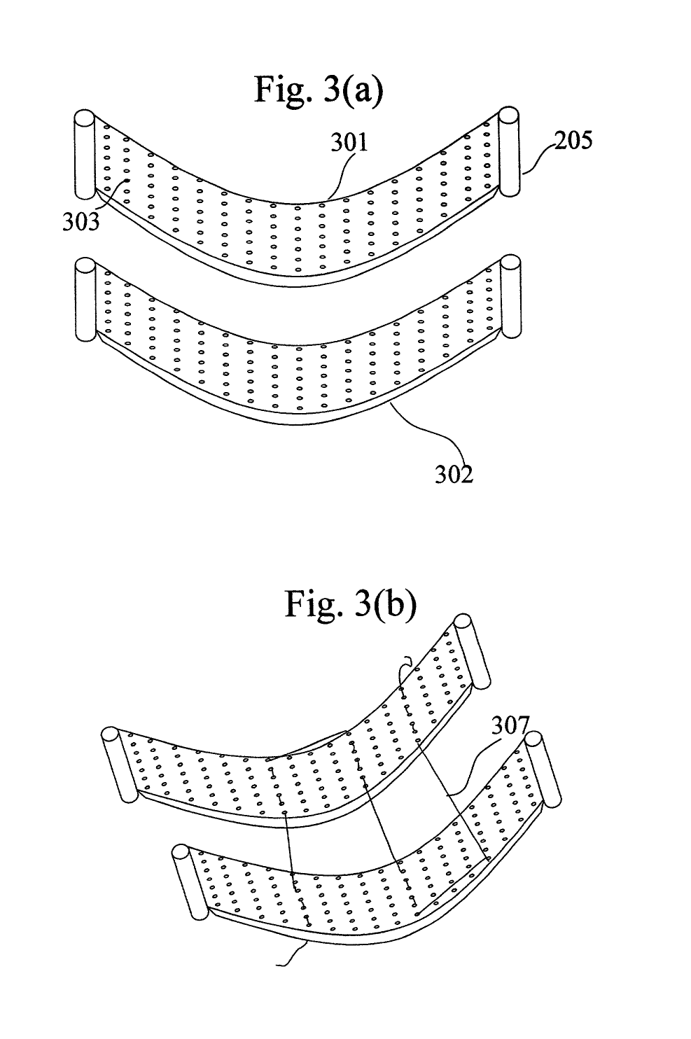

FIG. 3(a) shows floss attachment devices (301, 302) that are covered with holes (303) instead of slits. The floss is threaded through whichever holes the user wants. Since there are many rows of holes, the user can adjust the height of the floss by threading it through a hole closer to the front of a floss attachment device or closer to the back of it.

FIG. 3(b) illustrates how height of the floss (307) can be adjusted by using floss attachment devices(301, 302) that are covered by rows of holes.

While specific embodiments of the invention have been illustrated and described herein, it is realized that other modifications and changes will occur to those skilled in the art. For example, there will be a wide variety of methods to improve on the floss attachment device. In our example, the floss attachment device is covered with either holes or slits. It is also possible to use different methods to hold the floss. The same methodology can be implemented for the mechanism used to the floss attachment devices together. It should be understood that the above particular examples are for demonstration only and are not intended as limitation on the present invention. It is therefore to be understood that the appended claims are intended to cover all modifications and changes as fall within the true spirit and scope of the invention.

What is claimed is:

1. A dental flossing device comprises:
(a) one or a plurality of floss attachment devices for holding the position of dental floss, and
(b) one or a plurality of dental flosses attached to said floss attachment devices, said dental flossing device allow a user to floss a plurality of teeth simultaneously.

2. The floss attachment devices in claim 1 comprise means for adjusting the location of said dental flosses.

3. The floss attachment devices in claim 1 comprise a plurality of thin slits for holding and adjusting the position of said dental flosses.

4. The floss attachment devices in claim 1 comprise a plurality of holes for holding and adjusting the position of said dental flosses.
